(19) United States
(12) Patent Application Publication
(10) Pub. No.: US 2003/0037066 A1
(43) Pub. Date: Feb. 20, 2003

(54) Delegating sort tasks between heterogeneous computer systems

(75) Inventor: Michael Rothschild, Ramot Hashavim (IL)

Correspondence Address: THE FIRM OF KARL F ROSS, 5676 RIVERDALE AVENUE, PO BOX 900, RIVERDALE (BRONX), NY, 10471-0900, US

(73) Assignee: NEWFRAME CORPORATION LTD.

(21) Appl. No.: 10/209,673

(22) Filed: Jul. 31, 2002

Related U.S. Application Data
(60) Provisional application No. 60/312,313, filed on Aug. 14, 2001.

(51) Int. Cl. G06F 7/00

(52) U.S. Cl. 707/104.1

(57) ABSTRACT

A task, activated on one computer system is delegated to heterogeneous computer systems, the input of the task, residing on a shared device, read for that task through a function using heterogeneous read and the output of the task written by a function using heterogeneous write, back to the shared device.

### CROSS REFERENCE TO RELATED APPLICATION

This application is a nonprovisional application for Ser. No. 60/312,313 filed Aug. 14, 2001.

### FIELD OF THE INVENTION

This invention relates to the field of sharing data and workload between possibly heterogeneous computer systems.

More specifically, it deals with a way to enable one computer system to manipulate files for an application that is executing on another computer system, avoiding the need to transmit the data back and forth between the heterogeneous computer systems through the use of heterogeneous read and write, and translating the sort request between the two computer systems.

Sort applications, statistical analysis batch applications and report writing applications are examples of applications that can readily enjoy this invention.

### BACKGROUND OF THE INVENTION

Sort operations currently consume approximately about 25% of the nightly computing resources in typical mainframe installations. Other batch utilities that, as the sort utilities have open system's equivalents also add to this load.

The mainframes in these installations are typically very loaded during the night, while other computer systems available in the organization are almost idle.

While, in most of these cases, the output of the sort or the other utilities is needed on the mainframe for further processing, this unbalanced load is disturbing and forces more frequent upgrades of the mainframe.

The purpose of the current invention is to ease the load on the mainframe through the delegation of some or parts of the operations from the mainframe to other available computers, using the increasing support for heterogeneous read and write, supplied by the various storage providers.

Another goal is to reduce the time needed for the completion of some operations through their distribution between a plurality of potentially heterogeneous computer systems.

### OBJECT OF THE INVENTION

It is the principal object of the present invention to provide an improved method of delegating sort tasks between heterogeneous computer systems.

### SUMMARY OF THE INVENTION

These objects and others which will become apparent hereinafter are attained, in accordance with the present invention in a system for delegating at least some of the load created by a process where the input of the process is available on an originating system and where the output of the process is needed on the originating system, to potentially heterogeneous helping systems, i.e. one or more additional computers, without copying the input to the heterogeneous helping systems environment and without copying the output to the originating system. The invention uses heterogeneous read and write functions to access the input to and create the output. The process which is distributed to the helping system can be a sort process, a statistical analysis process or a report creating process by way of example.

More particularly a method of operating a computer system in which a multiplicity of operations are carried out within the system under the control of the system processor and batch processing goes on therein, in this method, a class of tasks is identified which can be capable of being effective without a need to read data from and write data into memory in each operation in the main system. Those tasks can be sort tasks, statistical analysis batch operations and report writing applications by way of example. According to the invention, the class of tasks, especially sort, is effective in at least one helping computer independent of the system, e.g. a mainframe, utilizing a computer having a respective processing and using a heterogeneous read function for data from the computer system and a heterogeneous writing function for outputting data to the system, thereby reducing the load on the computer resources of the system.

### BRIEF DESCRIPTION OF THE DRAWING

FIG. 1 is a block diagram which describes how the system works, in the case of an initiating system.

### SPECIFIC DESCRIPTION

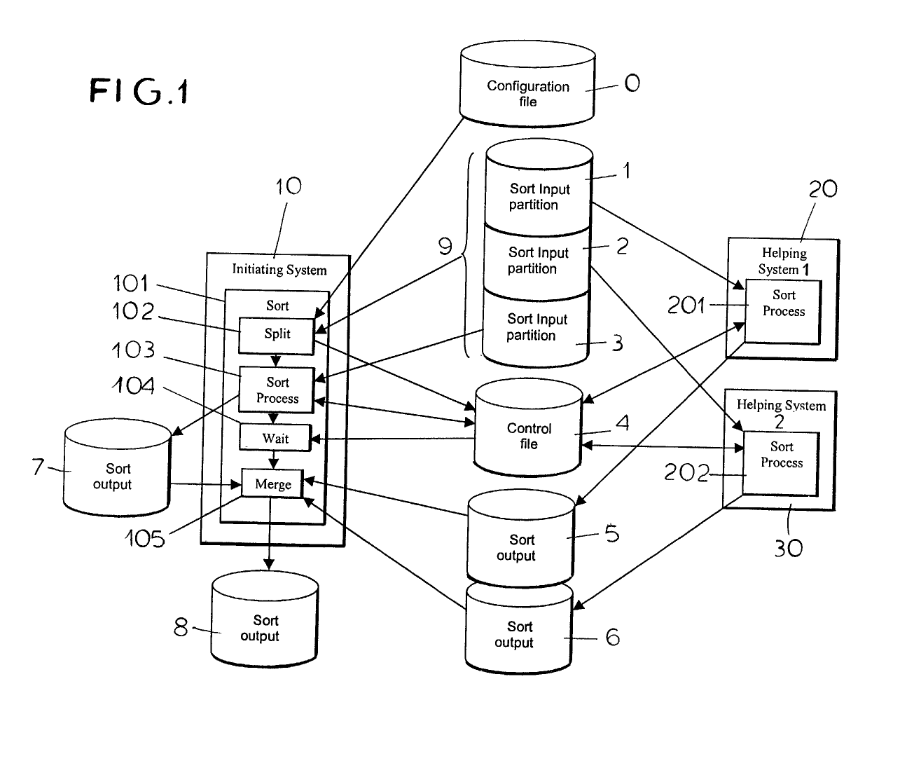

FIG. 1 contains a top-level description of the invention and its workings. In the initiating system 10, the invocation of the usual utility has been replaced by an invocation of a logically equivalent utility 101 that is based on the current invention, capable of delegating at least some of the load to the available helping systems. In this FIGURE, only two such helping systems are depicted—helping system 1 and helping system 2—but in general, any positive number of such systems can be used.

The equivalent utility 101 accepts the same input, or input with the same semantics, as the original utility. If the original utility is a sort utility then, in most cases, it is told by this input, what the file to be sorted is and what parts of the records in this file constitute the key according to which it is to be sorted. In this case the input also specifies the data types of the various parts of the key. If the original utility is one of statistical analysis then the various statistics and the data for these statistics are specified by this input. If the original utility is a report generator then the definition of the various reports and the data files they should be extracted from are parts of this input.

The various parts of the equivalent utility 101 are depicted here as consecutive steps in one procedure but alternative embodiments could replace them by dependent tasks controlled by a job scheduler. In this case, the wait step 104 would be replaced by a dependency of the Merge step 105 on the completion of Sub Task 103, Sub Task 201 and Sub Task 202. More generally, the Merge step would have been instructed to start only after all the Sub Task steps have completed.

The first step of the Equivalent utility 101 is the Split step 102. This step combines the information contained in the parameters supplied to the equivalent utility 101 as a whole (in the sort case, these parameters include the name of the file to be sorted 9 and the keys to be used), with the information contained in the configuration file 0 which includes the names of the servers available to perform this task and with information from the operating system about the size and location of the input file or files 9, to create the control file 4 specifying which server should operate on what part of the input.

The split step 102 could rely on additional information that could also be contained in the configuration file 0. It could, for example, take into account the power of each available server and the current load of this server.

When the split step terminates, the various Sub Tasks (in this case: 103, 201, 203) can be activated.

This activation can be initiated by the split step 102 itself or by an external scheduler.

Each Sub Task finds in the control file 4, the part of the input file or files 9 assigned to it.

In the case depicted in FIG. 1, Sub Task 103 finds input partition 3, Sub Task 101 finds Input Partition 1 and Sub Task 202 finds Input Partition 2.

Each Sub Task has to process its corresponding input partition and write the output on the corresponding output.

In this FIGURE, Sub Task 103 reads Input Partition 3, processes it and creates Output 7; Sub Task 201 reads Input Partition 1, processes it and creates Output 5 and Sub Task 202 reads Input Partition 2, processes it and creates Output 6.

Reading, processing and writing, however, are not straight forward since all the input and output files are shared by the potentially heterogeneous systems and while the Sub Task itself is also performed in these potentially heterogeneous systems, the results should look as if they have all been created by the Initiating System 10.

This is why the various Sub Tasks have to use heterogeneous read and write functionality to read and write their corresponding Input Partitions. This is also why, if the original utility is a sort utility, depending on the type of the input key, parts of the key's data may or may not be converted from the Initiating System's representation to an equivalent representation on the Helping Systems and then, after being sorted, converted back to the Initiating System's representation.

If, for example, the Initiating System 10 is an IBM mainframe and the Helping Systems 20 and 30 are HP-UX machines then character strings should not be converted from EBCDIC to ASCII since the order we want to create is the EBCDIC order. In this case, binary numbers should not be converted either since their representation is the same on both systems but the mainframe's floating point numbers should be converted to HP-UX floating point numbers and back and packed decimal numbers should be converted to and from some HP-UX appropriate representation like, depending on the precision, short, long or long long binary numbers or even character strings.

Once all the Sub Tasks have terminated, the Merge Step 105 can be initiated. To initiate the Merge Step 105 at the appropriate time, the Wait Step 104 can be used, as depicted in this FIGURE, to periodically verify the Control file 4 and detect the completion of all Sort Processes and then schedule the Merge Step 105. Another alternative for the timely activation of the Merge Step would be to use some existing scheduler, as already mentioned.

Note that although the Merge Step 105 is depicted as running on the Initiating System 10, this should not necessarily be the case.

It can be the task of the Split Step 102 to decide where the Merge Step 105 should run.

The Merge Step 105, as the Sub Tasks preceding it, may have to use the heterogeneous read and write functionality and the appropriate type conversions of parts of the key.

What the Merge Steps 105 does is, of course, to merge the outputs of the various Sub Tasks into the result output file or files, represented in this FIGURE by Output 8.

Once the Merge Step 105 has completed, the whole Equivalent Utility 101 is complete.

The Merge Step 105 only needs to be performed in cases where there are more than one Subtask. Otherwise it is not needed.

If the original utility is a sort utility then there are some additional cases, beyond the simple sort of an input file for the creation of an output file where the same technology can be used to at least some extent.

A typical case is when the sort to be replaced uses exits like the input and output exits supported by all conventional IBM mainframe sort utilities, termed, in this environment E15 and E35.

Such exits could be handled in any of the following ways or a combination thereof:

Provide equivalent exit routines in all the relevant Helping Systems. This requires some work and is not always possible but when implemented, it is the most efficient solution. Note that the input exit only needs to be implemented where Sub Tasks are performing and the output exit only needs to be implemented where the Merge Process or the only Sub Task is being performed.

Use communication, either over telecommunication lines, or through the disk controller, to communicate between an exit running on one system and a Sub Task or Merge Process running on another. This alternative is not as efficient as the other ones, but it could be the only available one.

Run the Merge Process on the Initiating System 10 just to avoid the need to perform the output exit elsewhere.

Run on the Initiating System 10 Pre Sort and Post Sort conversion steps with the sole purpose of running the exits.

This system is compatible with that of U.S. Pat. No. 5,758,125.

1. A method of operating a computer system in which a multiplicity of operations are carried out within said system under the control of at least one processor incorporated in said system and controlling batch processing therein, said method comprising the steps of:
(a) identifying a class of tasks in said batch processing capable of being effected without a need to read data from and write data into memory in each operation; and
(b) effecting said class of tasks in at least one helping computer independent of said system having a respective processor using a heterogeneous read function for data from said computer system and a heterogeneous write function for outputting data to said system, thereby reducing load on computer resources of said system.

2. The method defined in claim 1 wherein said tasks are file sorts.

3. The method defined in claim 1 wherein said computer system is a mainframe and said helping computer is another mainframe, a minicomputer or a microcomputer.

4. The method defined in claim 1 wherein said tasks are statistical analysis processes.

5. The method defined in claim 1 wherein said tasks are report creating processes.
